(19) United States
(12) Patent Application Publication
(10) Pub. No.: US 2005/0075442 A1
(43) Pub. Date: Apr. 7, 2005

(54) Fire retarded polymer composition

(76) Inventors: Grigory I Titelman, Haifa (IL); Samuel Bron, Yoqneam (IL); Michael Peled, Hatzav (IL)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/496,912

(22) PCT Filed: Nov. 27, 2002
(86) PCT No.: PCT/IL02/00956

(30) Foreign Application Priority Data
Nov. 29, 2001 (IL) 146821

(51) Int. Cl. C08K 3/38; C08K 3/10; C08K 3/18; C08K 5/02; C08K 3/04

(52) U.S. Cl. 524/495; 524/404; 524/430; 524/409; 524/464

(57) ABSTRACT

A fire retarded polymer composition is disclosed, which comprises a polymer component, at least one halogen-containing fire retardant and a heat expandable graphite. The polymer component is selected from among polystyrenes, polyesters and polyolefins. The halogen of the fire retardant is bromine or chlorine, and the total amount of the fire retardant and the heat expandable graphite is from about 6.5 to about 40% by weight. The composition may also contain a metal oxide fire retardant, such as antimony trioxide, but if so, it contains it in amounts much lower than those required in prior art compositions to achieve the same degree of fire retardancy. It is preferred that the heat expandable graphite be such as to expand 50 times or more on shock heating from room temperature to 900° C. The process by which the expandable graphite is produced is not critical, and it is known, for example, to produce it by oxidation of natural or artificial graphite.

### FIELD OF THE INVENTION

The present invention relates to fire retarded polymer composition having excellent fire retardancy, reduced corrosive gas and reduced smoke emission on burning.

### BACKGROUND OF THE INVENTION

It is desirable that polymer materials be flame-retarded to prevent fire accident or fire spreading when used, e.g., in insulating materials such as electric wires and cables; sheath materials; enclosures and internal parts of electric, electronic and office automation apparatus; interior materials of vehicles; building materials, etc. Many polymer materials for such uses are even required to be fire retarded by legislation. Known fire retardant additives used in polymer materials include halogen containing fire retardants, magnesium hydroxide, aluminum hydroxide, and phosphorous or phosphorous/nitrogen-containing compounds. These additives, however, have disadvantages.

The phosphorous type fire retardants, such as phosphoric acid esters or phosphonic acid esters, are effective in small amounts, but only in a few types of polymers, such as polyamides, polycarbonates and polyphenylene oxides. For general-purpose polymers, such as polyolefins, polyesters and polystyrenes, they produce practically no fire retardancy effect when alone.

Metal hydroxides fire retardants, such as magnesium hydroxide and aluminum hydroxide, are suited for polyolefins, but are required in large amounts to be effective, and large amounts impair mechanical properties, appearance, and other characteristics of the polymer materials. They do not emit smoke or corrosive gas, but it is difficult to achieve a high level of fire retardancy, for example, UL-94 V-0 for thin-wall articles (1.6 mm or 0.8 mm thickness).

The halogen containing fire retardants, which impart a higher level of fire retardancy (for example, UL-94 V-0, V-1 or V-2) at relatively small amounts of additive, generate soot or smoke in a large amount on burning. Usually, polymer materials containing halogen containing fire retardants require synergistic additives such as antimony oxide. Furthermore, the halogen containing fire retardants may emit more or less acidic substances and antimony derivatives at the time of fire, which produce adverse effects on human health or apparatus in the vicinity of a fire site.

Therefore, there is a demand for fire retarded polymer materials, which provide a higher level of fire retardancy in a smaller amount of fire retardant additive and emit less smoke and less corrosive gas. A promising way to satisfy this demand is the use of a halogen containing fire retardant with a significantly reduced bromine content and total or partial replacement of the antimony oxide. Consequently, techniques have been disclosed in which both heat expandable graphite and halogen type fire retardant are used in combination to yield flame retardancy in crosslinked polymers and elastomers.

GB 2,248,030 discloses an open-cell cross-linked polyolefin foam containing phosphorous- or bromine-based fire retardants. For this foam to stand very high temperatures (1000° C.), the patent proposes to coat at least a part of the surface of the foam with a suspension of heat expandable graphite (HEG) in an adhesive agent. Thus, in this system HEG mainly plays a thermal protection role, it is not in a direct contact with any of the above mentioned flame retardants and it is not supposed to play any role in flame retardancy.

WO 00/23513 discloses an adhesive composition for coating a metal foil for an electromagnetic interference shielding application, with an adhesive consisting of an acrylic-based coat, decabromodiphenyl oxide (DECA), antimony trioxide and HEG. Ethylene bis(tetrabromophtalimide), referred to as Saytex BT-93, has been mentioned as a bromine source for a complex epoxy composition already fire retarded by a phosphorous-containing fire retardant-plasticizer containing HEG (EP 0,814,121, 1997). BT-93 was used together with the above mentioned fire retardant plasticizer, HEG, aluminum trihydrate, zinc borate, melamine phosphate and other additives. There is no mention of the possibility that HEG and BT-93 alone would yield flame retardancy.

A paper of Tsu-Hwang Chuang and Wenieng Guo published in Handbook of IFK'99, Beijing, describes the use of a combination of a decabromodiphenyl oxide and heat expandable graphite, effective in terms of oxygen index in highly filled cross-linked elastomer. The compositions described in this paper have a reduced content of elastomer (ethylene-propylene-diene monomer rubber), processed at relatively low temperature (up to 150° C.) and in the presence of dicumyl peroxide and sulfur as cross-linking agents.

Generally, in a flame retarded polymer composition a particular fire retardant additive may have a quite different fire retardation performance depending on the polymer matrix, other additives and processing conditions. Therefore, in the light of data and experience accumulated in the art, a fire retardant additive which is effective in a highly filled cross-linked elastomer would not automatically show a fire retardant activity when added to other kinds of polymers. This conclusion is true in particular in polymers selected from the group comprising polystyrenes, polyolefins and polyesters that do not form char or cross-link themselves under flame.

It is the purpose of this invention to provide a fire retarded polymer composition, which has excellent fire-retardancy, emits less acidic gas and less smoke on burning.

It is another purpose to provide such a fire retarded polymer composition wherein the polymer is selected from the group consisting of polystyrenes, polyolefins and polyesters.

It is a further purpose to provide a fire retardant combination for obtaining polymer compositions having the aforesaid properties.

Other purposes and advantages of the invention will appear as the description proceeds.

### SUMMARY OF INVENTION

The applicant has found that when heat expandable graphite (HEG) and any halogen containing fire retardant are used as a fire retardant combination in a polymer selected from the group consisting of polystyrenes, polyolefins and polyesters, a high level of fire retardancy of the polymer composition is provided.

The high level of fire retardancy of the polymer composition may be accomplished using a fire retardant combination of a halogen containing fire retardant (HFR) and HEG. No additional, conventionally used FRs, such as metal oxide, particularly antimony trioxide, are needed in the fire retardant combination and the fire retarded polymer composition of the invention (so-called antimony-free fire retarded polymer composition). Alternatively, a high level of fire retardancy may be accomplished when both bromine-containing YR and metal oxides are present in a fire retarded polymer composition but in amounts significantly lower than those conventionally used (as demonstrated hereinafter).

The invention, therefore, provides fire retarded polymer composition containing a polymer selected from the group consisting of polystyrenes, polyolefins or polyesters, and a fire retardant combination comprising heat expandable graphite and at least one halogen containing fire retardant. The fire retardant combination of the present invention is either free of metal oxides, particularly antimony oxide, or it is a combination containing a significantly reduced amount of the metal oxides, particularly antimony oxide. The metal oxides may be for e.g. any conventionally used metal oxide, which may exhibit synergism with a halogen containing fire retardant.

The halogen-FR and the metal oxide, may be single components or mixtures of components of the same category. The heat expandable graphite should preferably be able to change its specific volume by expanding 50 times or more, on shock heating from room temperature to 900° C. The use of heat expandable graphite in combination with halogen containing fire retardant, according to the invention, allows:
a) total eliminating of metal oxide from the composition, while the content of halogen in halogen-containing fire retardant is maintained at or even below the usually required level, namely the level conventionally used in the absence of HEG but in the presence of metal oxide (as demonstrated hereunder); or alternatively,
b) using a combination of a halogen-containing fire retardant and metal oxide, wherein the content of halogen and of metal oxide are reduced, even to half or less than the contents usually required (as demonstrated hereinafter).

The invention therefore provides a fire retarded polymer composition, which comprises preferably one or more polymers preferably characterized by the incapacity of autonomous formation of char or of auto cross-linking under flame and selected from the group consisting of polystyrenes and/or polyesters and/or polyolefins, and containing a fire retardant combination of either two (HEG and halogen-containing FR) or three (HEG, halogen-containing FR and metal oxide) components.

The invention therefore provides a fire retarded polystyrene or polyester composition, which comprises:
Component A: a polymer selected from the polystyrenes or polyesters group at a percent weight which balances to 100% by weight the following fire retardant combination:
Component B: 2 to 15% (preferably 2 to 6%) by weight of heat expandable graphite,
Component C: a halogen-containing fire retardant in an amount corresponding to 2 to 11% (preferably 2 to 8.5%) by weight of halogen; and, optionally,
Component D: 0 to 3.4% (preferably 0 to 2.2%) by weight of metal oxide.

The invention further provides a fire retarded polyolefin composition, which comprises:
Component A: a polymer selected from the polyolefins group at a percent weight which balances to 100% by weight the following fire retardant combination:
Component B: 5 to 13.5% (preferably 6 to 8%) by weight of heat expandable graphite,
Component C: a halogen-containing fire retardant in an amount corresponding to 4 to 22% (preferably 5 to 15%) by weight of halogen; and, optionally,
Component D: 0 to 7% (preferably 0 to 4%) by weight of metal oxide.

The component A of the fire retarded polymer composition of the present invention is a polymer (or a combination of polymers) characterized by lacking autonomous capability of forming char, or of auto cross-linking under flame, selected from the group consisting of polystyrenes, polyolefins and polyesters.

The polystyrenes in the present invention are polymers produced from a styrene type monomer including styrene and methylstyrene. The polystyrenes includes, inter alia, homopolymers of styrene, rubber modified high-impact polystyrenes (hereinafter referred to as “HIPS”), and acrylonitrile-butadiene-styrene copolymers (hereinafter referred to as “ABS”).

The polyolefins in the present invention are polyethylene, polypropylene and copolymers of propylene with ethylene. The polyolefins include, inter alia, homopolymers of ethylene (high density polyethylene referred to as “HDPE”, low density polyethylene, hereinafter referred to as “LDPE”, linear low density polyethylene referred to as “LLDPE”), homopolymers of polypropylene (hereinafter referred to as “PP homo-polymer”), block or random copolymers of propylene with ethylene (hereinafter referred to as “PP co-polymer”).

The polyesters in the present invention are polymers produced by a polycondensation reaction between terephthalic acid and a glycol. The polyesters include, inter alia, polycondensation products of terephthalic acid with ethylene glycol (polyethylene terephthalate refered to as “PET”) or with butylene glycol (polybutylene terephthalate refered to as “PBT”).

The polymers (Component A) employed in the present invention are polymers with no autonomous possibility to form char or cross-link themselves under flame. The present invention is not limited to the use of a single polymer, but said Component A may be a mixture of two or more of the polystyrenes, polyolefins and/or polyesters with one another or with polymer or polymers of different types, selected for imparting desired flame retarded properties to the final polymer composition.

The component B of the fire retarded polymer composition of present invention is heat expandable graphite which is well-known in the art, and it is further described by Titelman, G. I., Gelman, V. N., Isaev, Yu. V and Novikov, Yu. N., —Material Science Forum, Vols. 91-93, 213-218, (1992) and in U.S. Pat. No. 6,017,987. The heat expandable graphite is derived from natural graphite or artificial graphite, and upon rapid heating from room temperature to 900° C. it expands in the c-axis direction of the crystal (by a process so-called exfoliation or expansion). In addition to expanding in the c-axis direction of the crystal, the heat expandable graphite expands a little in the a-axis and the b-axis directions, as well. The exfoliation degree, or the expandability of HEG depends on the rate of removing the volatile compounds during rapid heating. The expandability value in the present invention relates to the ratio of the specific volume obtained following heating to a temperature of 900° C., to the volume at room temperature. A specific volume change of HEG in the present invention is preferably not less than 50 times for that range of temperature change (room temperature to 900° C.). Such an expandability is preferred because a HEG having a specific volume increase by at least 50 times, during rapid heating from room temperature to 900° C., has been found to produce a much higher degree of fire retardancy compared to a graphite that is heat expandable but has a specific volume increase of less than 50 times in the aforesaid heating conditions. 10% to 40% weight loss of HEG is due to volatile compounds removed in the aforesaid heating conditions at the volume expandability of 50 times and more. The HEG having a weight loss of less than 10%, during rapid heating, provides a specific volume increase of less than 50 times.

Increasing the weight loss of HEG to more than 40% under the aforesaid heating conditions, does not lead practically to further improvement in the fir retardancy of polymer composition.

The heat expandable graphite used in the present invention can be produced in different processes and the choice of the process is not critical. It can be obtained, for example, by an oxidation treatment of natural graphite or artificial graphite. The oxidation is conducted, for example, by treatment with an oxidizing agent such as hydrogen peroxide, nitric acid or another oxidizing agent in sulfuric acid. Common conventional methods are described in U.S. Pat. No. 3,404,061, or in SU Patents 1,657,473 and 1,667,474. Also, the graphite can be anodically oxidized in an aqueous acidic or aqueous salt electrolyte as described in U.S. Pat. No. 4,350,576.

In practice, the commercial grades of the heat expandable graphite are usually manufactured via an acidic technology.

The heat expandable graphite, which is produced by oxidation in sulfuric acid or a similar process as described above, can be slightly acidic depending on the process conditions. When the heat expandable graphite is acidic, a corrosion of the apparatus for production of the polymeric composition may occur. For preventing such corrosion heat expandable graphite should be neutralized with a basic material (alkaline substance, ammonium hydroxide, etc.).

The particle size of the heat expandable graphite used in the present invention affects the expandability degree of the HEG and, in turn, the fire retardancy of the resulting polymer composition. The HEG under fire decomposes thermally into a char of expanded graphite, providing a thermally insulating or otherwise protective barrier, which resists further oxidation. The heat expandable graphite of a preferred particle size distribution contains up to 25%, more preferably from 1% to 25%, by weight particles passing through a 75-mesh sieve. The HEG containing more than 25% by weight particles passing through a 75-mesh sieve, will not provide the required increase in specific volume and consequently, will not provide the sufficient fire retardancy. The heat expandable graphite containing particles passing through a 75-mesh sieve at a content lower than 1% by weight, may slightly impair the mechanical properties of the resulting polymer composition. The dimensions of the largest particles of HEG, beyond 75 mesh, should be as known in the art, in order to avoid the deterioration of the properties of the polymer composition. In a preferred embodiment, the surface of the heat expandable graphite particles may be surface-treated with a coupling agent such as a silane-coupling agent, or a titanate-coupling agent in order to prevent the adverse effects of larger particles on the properties of the fire retarded polymer composition. A coupling agent can be separately added to the composition, as well.

Component C in the present invention may be any commonly used halogen containing fire retardant. A suitable halogen-containing fire retardant may:
1. contain chlorine or bromine atoms;
2. have any one of various known molecular structures, and correspondingly different molecular weights (for example, it may be decabromodiphenyl oxide and decabromodiphenyl ethane, brominated trimethylphenyl indane, chlorine- or bromine-containing cycloaliphatic compounds, tetrabromobisphenol A or tetrabromobisphenol A bis(2,3 dibromopropyl ether) or tetrabromobisphenol A based epoxy, chlorinated paraffin, chlorinated polythylene, pentabromobenzyl acrylate or poly(pentabromobenzyl acrylate)); or
3. contain different heteroatoms in the molecule (for example, phosphorus in tris-(halogen-substituted propyl) phosphates; nitrogen in tris-(tri-halogen-substituted phenyl) cyanurate; or sulfur in tetrabromobisphenol-S bis(2,3 dibromopropyl ether).

The present invention is not limited to the use of a single halogen-containing fire retardant. Said Component C may be a mixture of two or more different halogen-containing fire retardants as herein before mentioned that may be suitable for obtaining the necessary halogen content in the desired polymeric material, or a mixture of two or more of halogen-containing fire retardants them with fire retardants of other types.

Component D in the present invention may be any metal oxide, which exhibits synergism with the halogen-containing fire retardant of Component C and provides a high level of fire retardancy. Suitable metal oxide includes, inter alia, antimony trioxide, antimony pentaoxide, zinc oxide, zinc borate, ferric oxide and another. Among them, those containing antimony oxides produce high fire retardancy.

In the composition of present invention in which Component D is totally eliminated from the fire retarded polymer (i.e. metal oxide-free composition) Component B and Component C are used together in the following amount:
(a) from 6.5 to 30.1% (preferably from 6.5 to 26.3%) by weight in compositions rated V-O, V-1 or V-2 containing any polymer selected from the polystyrenes or polyester groups and the component A is added to balance the composition to 100 wt %,
(b) from 24.3 to 40% (preferably from 24.3 to 30.3%) by weight in compositions rated V-0 or V-1 containing any polymer selected from the polyolefins group and Component A is added to balance the composition to 100 wt %.

With a total amount of Components B and C, together, of less than 6.5% (a) or 24.3% (b) by weight, the fire retardancy of the polymer composition is not sufficient. On the other hand, an increase of total amount of Components B and C to more than 30.1% by weight in composition (a) or to a more than 40% by weight in composition (b) practically does not lead to a further increase in fire retardancy but may deteriorate the properties of the polymer composition.

According to the present invention, a polymer composition with a high level of fire retardancy (UL94 V-0 or V-1) may be obtained using Component D in addition to Components B and C. In said fire retarded polymer composition the amounts of Component C and of Component D may be reduced to less than a half as compared to the amounts usually required in halogen-containing fire retarded compositions (as demonstrated hereinafter).

When all three components (B, C and D) are used in the composition of the invention, the total amounts range:
(a) from 7.2 to 21.5% (preferably from 7.2 to 16.7%) by weight in compositions containing any polymer selected from the polystyrenes or polyesters groups, and the component A is added to balance the composition to 100 wt %. With a total amount of Components B, C and D of 9% by weight or less, the fire retardancy of the polystyrene based fire retarded compositions decreases to V-2. It should be pointed out, however, that this level of fire retardancy may reached without Component D at lower amounts of Components B and C.
(b) from 13.9 to 34% (preferably from 16 to 20%) by weight in compositions containing any polymer selected from the polyolefins group and Component A is added to balance the composition to 100 wt %. With a total amount of Components B, C and D, together, of less than 7.2% (a) or 13.9% (b) by weight, the fire retardancy of the polymer composition is not sufficient. Increasing the total amount of Components B, C and D beyond 34% by weight, does not lead to a further increase in fire retardancy, but the mechanical properties of the polyolefin based composition may be slightly deteriorated.

The polymer composition of the present invention may further contain other fire retarding additives, such as a metal hydroxide like magnesium hydroxide or aluminum hydroxide, in such an amount that the effects of the present invention are not impaired. Further, the polymer composition may contain other kinds of additives such as colorants, antioxidants, light stabilizers, light absorbing agents, process oils, coupling agents and lubricants, blowing agents, anti-dripping agents, cross-linking agents and fillers.

The above-described fire retardation technique of the present invention produced a polymer material having excellent fire retardancy, and emitting less corrosive gas and less smoke on burning.

### DETAILED DESCRIPTION OF PREFERRED EMBODIMENTS

The present invention is described below more specifically by reference to examples without limiting the invention in any way.

Non-limitative examples of Components A, B, C, and D, are set forth below:

Component A:

(A1) HIPS (Styron 472, Dow)
(A2) ABS (PA-717C, Chi-Mei)
(A3) PP homo-polymer (Capilene; G 86E, Carmel Olefins.)
(A4) PP co-polymer (Capilene, SG50, Carmel Olefins)
(A5) LDPE (Ipethine 320, Carmel Olefins)
(A6) PBT (Celanex, Hoechst)
   Component B
Commercially available grades used in the following examples are:
(B1) Heat expandable graphite (GREP-EG, Tosoh)
(B2) Heat expandable graphite (NORD-MIN 250, NRC)
Heat expandable graphite synthesized by the applicant by a commonly used technology, wherein the finished product was neutralized by aqueous ammonia, was also used in the following examples:
(B3) Heat expandable graphite
(B4) Heat expandable graphite

The properties of components B1 to B4 are shown in Table 1.

TABLE 1
Properties of HEG B1-B4

| | B1 | B2 | B3 | B4 |
|---|---|---|---|---|
| Sulfur content, % | 3.00 | 3.25 | 2.70 | 6.00 |
| Nitrogen content, % | 0.70 | 0.22 | 0.58 | 3.30 |
| Carbon content, % | 86.6 | 81.10 | 70.00 | 63.20 |
| Hydrogen content, % | 1.10 | 1.00 | 2.20 | 2.10 |
| Apparent density, gr/l | 690 | 475 | 170 | 260 |
| Weight loss on shock heating from | 13.0 | 21.0 | 32.0 | 38.0 |
| room temperature to 900° C. | | | | |
| Expandability on shock heating | 73 | 86 | 80 | 100 |
| from room temperature to 900° C. | | | | |

Component C
(C1) Decabromodiphenyl oxide (FR-1210, DSBG)
(C2) Decabromodiphelyl ethane (Saytex-8010, Albemarle)
(C3) Brominated trimethylphenyl indan (FR-1808, DSBG)
(C4) Tris(tribromoneopentyl) phosphate (FR-370, DSBG)
(C5) Tetrabromobisphenol A (FR-1524, DSBG)
(C6) Tetrabromobisphenol A based epoxy (F-2016, F-2400, DSBG)
(C7) Tetrabromobisphenol A bis(2,3 dibromopropyl ether) (FR-720, DSBG)
(C8) Tris-(tribromophenyl) triazine (FR-245, DSBG).
(C9) Chlorinated paraffi (Chlorez 760, Occidental)
(C10) Poly(pentabromobenzyl acrylate) (FR-1025, DSBG)
   Comonent D
(D 1) Antimony trioxide

The antimony trioxide can be used as a powder, or as a master batch of antimony trioxide in either a styrene based polymer for polystyrenes based fire retarded compositions or in an olefin based polymer for polyolefins based fire retarded compositions.

In order to compare the composition of the present invention with conventional compositions known in the art, referenced examples (Ref) were prepared and hereinafter provided, in which conventional amounts of halogen-containing FR and metal oxide are used.

### EXAMPLES 1-44 AND COMPARATIVE EXAMPLES REF. 1-8

Either a HIPS or a ABS or PBT was used as Component A. Various amounts of (B), (C) and (O) as shown in Tables 2-5, were admixed with the Component A in a granulated form. Mixing was done in a Brabender mixer of 55 cm⁸ volume capacity at 50 rotations per minute for a desired time and at a desired temperature, specific for each polymer and the corresponding series of experiments. Specimens of 3.2 mm or 1.6 mm thickness were prepared by compression molding in a hot press at 200° C. HIPS, ABS) and at 250° C. (PBT), cooling to room temperature and cutting to standard test pieces.

The flammability was tested by the limiting oxygen index (hereinafter referred to as “LOI”) method, according to ASTM D-2863 and by UL-94 test (Underwriters Laboratories) with bottom ignition by a standard burner flame for two successive 10-second intervals. Five test-pieces of each composition were tested and the burning time, given in each example, are averages of all five tested pieces.

Tables 2-4 summarize fire retarded polystyrene or polyester based compositions, which provide a high level of fire retardancy of the polymer material (V-0 or V-1). In the Comparative Examples (marked as Ref 1, 2, 4, or 5) neither the single use of Component B (heat expandable graphite) nor the use of Component B together with the Component D (antimony trioxide) resulted in flame retardancy according to the UL-94 burning test.

In the Comparative Examples (marked as Ref. 3, 6 and 7), the fire retarded polymer composition shows a high fire retardancy (both by LOI value and V-0 rating in the UL94 burning test) at 11% bromine with 4.3% antimony trioxide (in HIPS), or 6.8% antimony trioxide (in ABS), and at 10% bromine with 4.0% antimony trioxide (in PBT). The use of Component B (heat expandable graphite) allows either to eliminate totally the Component D from the composition, while preserving the halogen content of Component C (Examples 1-8, Table 2, Examples 23 and 24, Table 3), or to reduce the content of Component C and of Component D to about a half (Examples 9-15, Table 2, Examples 30 and 31, Table 3). All compositions provide V-0 or V-1 rating in the UL-94 burning test and LOI values higher than that of the Comparative Examples. The addition of Component B (heat expandable graphite) works both with HIPS, ABS and PBT, either with a chlorine- or a bromine-containing fire retardant, independently of the chemical and molecular structure of the fire retardant.

TABLE 2

| | | | | | | | | | | | | | | |
|---|---|---|---|---|---|---|---|---|---|---|---|---|---|---|
| Example | | | | | | | | | | | | LOI, | UL-94 | Burning |
| No. | A | Wt. % | B | Wt. % | C | Wt. % | Br % | Cl % | D | Wt. % | Total FR % | O₂ | 3.2 mm | time, sec |

Example (metal oxide free compositions)

| | | | | | | | | | | | | | | |
|---|---|---|---|---|---|---|---|---|---|---|---|---|---|---|
| 1 | A1 | 76.4 | B1 | 10 | C2 | 13.6 | 11 | | — | 0 | 23.6 | 31.7 | V-0 | 0.8 |
| 2 | A1 | 74.9 | B1 | 10 | C3 | 15.1 | 11 | | — | 0 | 25.1 | 32.0 | V-0 | 1.2 |
| 3 | A1 | 74.1 | B1 | 10 | C4 | 15.9 | 11 | | — | 0 | 25.9 | 33.8 | V-0 | 0.4 |
| 4 | A1 | 73.7 | B1 | 10 | C7 | 16.3 | 11 | | — | 0 | 26.3 | 33.2 | V-0 | 0.7 |
| 5 | A1 | 74.5 | B1 | 10 | C9 | 15.5 | | 11 | — | 0 | 25.5 | | V-1 | 5.5 |
| 6 | A2 | 74.9 | B1 | 10 | C3 | 15.1 | 11 | | — | 0 | 25.1 | 33.2 | V-0 | 1.1 |
| 7 | A2 | 74.1 | B1 | 10 | C4 | 15.9 | 11 | | — | 0 | 25.9 | 37.0 | V-0 | 0.6 |
| 8 | A2 | 73.7 | B1 | 10 | C7 | 16.3 | 11 | | — | 0 | 26.3 | 35.8 | V-0 | 0.7 |

Example (compositions containing reduced content both metal oxide and bromine)

| | | | | | | | | | | | | | | |
|---|---|---|---|---|---|---|---|---|---|---|---|---|---|---|
| 9 | A1 | 80.3 | B1 | 10 | C3 | 7.5 | 5.5 | | D1 | 2.2 | 19.7 | 31.0 | V-0 | 0.6 |
| 10 | A1 | 79.8 | B1 | 10 | C4 | 8.0 | 5.5 | | D1 | 2.2 | 20.2 | 34.0 | V-0 | 1.4 |
| 11 | A1 | 76.7 | B1 | 10 | C7 | 8.1 | 5.5 | | D1 | 2.2 | 20.3 | 33.9 | V-0 | 1.0 |
| 12 | A1 | 80.0 | B1 | 10 | C9 | 7.8 | | 5.5 | D1 | 2.2 | 20.0 | | V-0 | 1.8 |
| 13 | A2 | 79.1 | B1 | 10 | C3 | 7.5 | 5.5 | | D1 | 3.4 | 20.9 | 36.3 | V-0 | 1.2 |
| 14 | A2 | 78.6 | B1 | 10 | C4 | 8.0 | 5.5 | | D1 | 3.4 | 21.4 | 37.5 | V-0 | 0.4 |
| 15 | A2 | 78.5 | B1 | 10 | C7 | 8.1 | 5.5 | | D1 | 3.4 | 21.5 | 36.4 | V-0 | 0.9 |

Comparative example

| | | | | | | | | | | | | | |
|---|---|---|---|---|---|---|---|---|---|---|---|---|---|
| Ref. 1 | A1 | 90.0 | B1 | 10 | — | 0 | | — | 0 | 10 | | NR | |
| Ref. 2 | A1 | 85.7 | B1 | 10 | — | 0 | | D1 | 4.3 | 14.3 | | NR | |
| Ref. 3 | A1 | 80.6 | B1 | 0 | C3 | 15.1 | 11 | D1 | 4.3 | 19.4 | 28.4 | V-0 | 0.1 |
| Ref. 4 | A2 | 90.0 | B1 | 10 | — | 0 | | — | 0 | 10 | | NR | |
| Ref. 5 | A2 | 83.2 | B1 | 10 | — | 0 | | | 6.8 | 16.8 | | NR | |
| Ref. 6 | A2 | 76.9 | B1 | 0 | C7 | .16.3 | 11 | D1 | 6.8 | 23.1 | 30.9 | V-0 | 1.0 |

TABLE 3

| | | | | | | | | | | | | | |
|---|---|---|---|---|---|---|---|---|---|---|---|---|---|
| Example | | | | | | | | | | | LOI, | UL-94 | Burning |
| No. | A | Wt. % | B | Wt. % | C | Wt. % | Br % | D | Wt. % | Total FR % | % O₂ | 3.2 mm | time, sec |

Example (metal oxide free compositions)

| | | | | | | | | | | | | | |
|---|---|---|---|---|---|---|---|---|---|---|---|---|---|
| 16 | A1 | 69.1 | B1 | 15 | C3 | 15.1 | 11 | — | 0 | 30.1 | 31.8 | V-0 | 1.4 |
| 2 | A1 | 74.9 | B1 | 10 | C3 | 15.1 | 11 | — | 0 | 25.1 | 32.0 | V-0 | 1.2 |
| 17 | A1 | 79.9 | B1 | 5 | C3 | 15.1 | 11 | — | 0 | 20.1 | 29.1 | V-0 | 2.9 |
| 18 | A1 | 78.2 | B1 | 10 | C3 | 11.8 | 8.5 | — | 0 | 21.8 | 30.7 | V-0 | 2.1 |
| 19 | A1 | 73.3 | B1 | 10 | C6 | 16.7 | 8.5 | — | 0 | 26.7 | 27.8 | V-0 | 2.4 |
| 20 | A1 | 77.3 | B1 | 10 | C8 | 12.7 | 8.5 | — | 0 | 22.7 | 27.8 | V-0 | 2.3 |
| 21 | A1 | 80.3 | B1 | 10 | C3 | 9.7 | 7.0 | — | 0 | 19.7 | 29.6 | V-0 | 2.5 |
| 22 | A1 | 82.3 | B1 | 8 | C3 | 9.7 | 7.0 | — | 0 | 17.7 | 30.0 | V-0 | 2.5 |
| 23 | A6 | 71.1 | B1 | 10 | C6 | 18.9 | 10 | — | 0 | 28.9 | — | V-0 | 0.8 |
| 24 | A6 | 75.7 | B1 | 10 | C10 | 14.3 | 10 | — | 0 | 24.3 | — | V-0 | 0.9 |

Example (compositions containing reduced content both metal oxide and bromine)

| | | | | | | | | | | | | | |
|---|---|---|---|---|---|---|---|---|---|---|---|---|---|
| 9 | A1 | 80.3 | B1 | 10 | C3 | 7.5 | 5.5 | D1 | 2.2 | 19.7 | 31.0 | V-0 | 0.6 |
| 25 | A1 | 82.3 | B1 | 8 | C3 | 7.5 | 5.5 | D1 | 2.2 | 17.7 | 32.1 | V-0 | 0.4 |
| 26 | A1 | 83.1 | B1 | 8 | C3 | 6.9 | 5.0 | D1 | 2.0 | 16.9 | 30.0 | V-0 | 0.3 |
| 27 | A1 | 80.2 | B1 | 8 | C6 | 9.8 | 5.0 | D1 | 2.0 | 19.8 | 28.7 | V-0 | 0.9 |
| 28 | A2 | 81.5 | B1 | 8 | C8 | 7.5 | 5.0 | D1 | 3.0 | 18.5 | 32.8 | V-0 | 0.1 |
| 29 | A1 | 85.1 | B1 | 6 | C3 | 6.9 | 5.0 | D1 | 2.0 | 14.9 | 30.3 | V-0 | 1.1 |
| 30 | A6 | 80.5 | B1 | 8 | C6 | 9.5 | 5.0 | D1 | 2.0 | 19.5 | — | V-0 | — |
| 31 | A6 | 82.8 | B1 | 8 | C10 | 7.2 | 5.0 | D1 | 2.0 | 17.2 | — | V-0 | 0.0 |
| 32 | A1 | 90.8 | B1 | 4 | C3 | 4.2 | 3.0 | D1 | 1.0 | 9.2 | 24.2 | V-1 | 9.3 |

Comparative example

| | | | | | | | | | | | | | |
|---|---|---|---|---|---|---|---|---|---|---|---|---|---|
| Ref. 3 | A1 | 80.6 | — | 0 | C3 | 15.1 | 11 | D1 | 4.3 | 19.4 | 28.4 | V-0 | 0.1 |
| Ref. 7 | A6 | | — | 0 | C10 | 14.3 | 10 | D1 | 4 | 18.3 | — | V-0 | 0.0 |

TABLE 4

| | | | | | | | | | | | |
|---|---|---|---|---|---|---|---|---|---|---|---|
| Example | | | | | | | | | LOI, | UL-94 | Burning |
| No. | A | Wt. % | B | Wt. % | C | Wt. % | Br % | Total FR % | % O₂ | 3.2 mm | time, sec |

Example (metal oxide free compositions)

| | | | | | | | | | | | |
|---|---|---|---|---|---|---|---|---|---|---|---|
| 33 | A1 | 79.6 | B1 | 10 | C1 | 10.4 | 8.5 | 20.4 | 30.6 | V-0 | 1.1 |
| 34 | A1 | 79.6 | B2 | 10 | C1 | 10.4 | 8.5 | 20.4 | 32.1 | V-0 | 1.0 |
| 35 | A1 | 79.5 | B2 | 10 | C2 | 10.5 | 8.5 | 20.5 | 29.9 | V-0 | 0.7 |
| 18 | A1 | 78.2 | B1 | 10 | C3 | 11.8 | 8.5 | 21.8 | 30.7 | V-0 | 2.1 |
| 36 | A1 | 78.2 | B2 | 10 | C3 | 11.8 | 8.5 | 21.8 | 29.6 | V-0 | 1.4 |
| 37 | A1 | 78.2 | B3 | 10 | C3 | 11.8 | 8.5 | 21.8 | 28.7 | V-0 | 2.4 |
| 38 | A1 | 78.2 | B4 | 10 | C3 | 11.8 | 8.5 | 21.8 | 30.1 | V-0 | 1.5 |

A total amount of fire retardant combination containing Components B and C is used for styrene or alkyl terephthalate metal oxide—free polymer composition in a loading range from 17.7% to 30.1% (Tables 2-4). Examples 2 (Table 3), 16 and 17 (Table 3) demonstrate that an increase of the content of Component B to 15% does not improve the fire retardancy, while decreasing the content of Component B to 5% still provides VW rating and a high value of LOI. Examples 18-22 (Table 3) demonstrate that the contents of Component B and Component C and, correspondingly, the total amount of the fire retardant combination in the fire retarded styrene polymer composition, may be further reduced. Examples 33-38 (Tables 4 and 5) demonstrate that any type of heat expandable graphite (Component B), may be used successfully to impart flame retardancy to polymers. The level of fire retardancy was non-dependent on the molecular structure of the fire retardant (Component C) and on the halogen content in Component C.

A total amount of a fire retardant combination containing the Component D in addition to Components B and C (compositions containing reduced content of both metal oxide and bromine) was used for styrene or alkylterephthalate polymers in a loading range from 9.2% to 21.5%. For example, as compared with a total amount of a conventional fire retardant combination containing Components C3 and D1 in an amount of 19.4% (Ret 3 in HIPS), a total amount of a fire retardant combination containing the Component D1 in addition to Components B and C3 was 14.9% (Table 3, Example 29). Examples 9-29, 32 (Table 3) demonstrate that a high level of fire retardancy (V-0 or V-1) can be achieved even when the contents of Component C and component D were reduced to significantly less than a half as compared to the amounts usually required in the state-of-the-art halogen-containing fire retardant compositions (Ref. 3, Table 3). Examples (9-32) further demonstrate that the level of fire retardancy of HIPS, ABS and PBT was non-dependent on the molecular structure of the fire retardant (Component C).

The amount of Component B may be further reduced (Examples 26, 29 and 32, Table 3). When the total amount of Components B, C and D was less than 9.2% by weight or less the fire retardancy of the fire retarded compositions decreases to V-2.

Table 5 demonstrates fire retarded styrenic compositions for fire retardancy rating of V-2 in the UL-94 burning test. Each of the demonstrated fire retardant combinations (both combinations containing Components B,C and D and metal oxide-free combinations) provide V-2 UL-94 rating to a fire retarded styrene polymer composition in an amount less than usually required in the state-of-the-art halogen-containing fire retardant composition (Ref. 8). A V-2 level of fire retardancy may be reached even at 2 wt % bromine when Component D is present in addition to Components B and C (Example 42, Table 5). On the other hand, a V-2 UL-94 level of fire retardancy may be reached without Component D (Example 40, Table 5) while using the same amounts of components B and C as are in compositions containing Component D (Example 43, Table 5). A further decrease in the content of Components B and C results in a lack of fire retardancy in the UL-94 burning test (Example 41, Table 5).

TABLE 5

| | | | | | | | | | | | |
|---|---|---|---|---|---|---|---|---|---|---|---|
| Example | | | | | | | | | | | UL-94 |
| No. | A | Wt. % | B | Wt. % | C | Wt. % | Br % | D | Wt. % | Total FR % | 1.6 mm |

Example (metal oxide free compositions)

| | | | | | | | | | | | |
|---|---|---|---|---|---|---|---|---|---|---|---|
| 39 | A1 | 91.8 | B1 | 4 | C3 | 4.2 | 3.0 | — | 0 | 8.2 | V-2 |
| 40 | A1 | 93.5 | B1 | 3 | C3 | 3.5 | 2.5 | — | 0 | 6.5 | V-2 |
| 41 | A1 | 95.2 | B1 | 2 | C3 | 2.8 | 2.0 | — | 0 | 4.8 | NR |

Example (compositions containing reduced content both metal oxide and bromine)

| | | | | | | | | | | | |
|---|---|---|---|---|---|---|---|---|---|---|---|
| 42 | A1 | 92.5 | B1 | 4 | C3 | 2.8 | 2.0 | D1 | 0.7 | 7.5 | V-2 |
| 43 | A1 | 92.5 | B1 | 3 | C3 | 3.5 | 2.5 | D1 | 1.0 | 7.5 | V-2 |
| 44 | A1 | 92.8 | B1 | 2 | C3 | 4.2 | 3.0 | D1 | 1.0 | 7.2 | V-2 |

Comparative example

| | | | | | | | | | | | |
|---|---|---|---|---|---|---|---|---|---|---|---|
| Ref. 8 | A1 | 89.7 | — | 0 | C3 | 8.3 | 6.0 | D1 | 2.0 | 10.3 | V-2 |

### EXAMPLES 18, 26, 33, 45-64 AND COMPARATIVE EXAMPLES REF 9-10

Either HIPS or ABS was used as Component A. The starting materials (Components A, B, C and D) were blended in a co-rotating twin-screw compounding machine using formulations as shown in Table 6. Regular amounts of antioxidants and anti-dripping agent, when they were applied, were added to the mixture on the expense of the polymer, as far as wt % is concerned, in the composition. The test-specimens were prepared by injection molding. Fire retardancy was evaluated by vertical flame test according to UL-94 as described above. The toughness of specimens was measured as Izod notched impact strength according to ASTM D 256. The UV stability was assessed by measuring the toughness decrease after specimen's exposure to the Xenon arc according to ASTM-4459/99 (300 W/m², 290-850 nm, 300 hours). The tensile properties were measured according to ASTM D 638-95. The flow ability was measured as melt flow index (MFI) according to ASTM D 1238-82 or as melt viscosity by capillary rheometry. The thermo-mechanical properties were measured as heat distortion test (HDT) according to ASTM D 648-72.

The Blooming Test was Conducted as Follows:

Following a visual inspection of the specimen, clean places without any visual defects were chosen and square samples about 1×1 cm were cut, coated with gold and investigated in SEM as zero time specimens. Similar samples were introduced in an oven at 65° C. for two weeks. When taken out of the oven, the specimens were gold plated and investigated in the SEM.

For imparting a high level of fire retardancy in styrenic polymers (V-0 rating both in 3.2 mm and in 1.6 mm thickness specimens) a conventional amount of 12 wt % bromine (in a bromine-containing fire retardant) and 6.8 wt % antimony trioxide are required (Comparative examples Ref. 9 and 10, Table 6). Examples 45-52 (Table 6) demonstrate that in the absence of component D (metal oxide-free compositions), 7.5-8.6 wt % of bromine (Component C) and 8-10 wt % of Component B in the fire retardant composition provide the required level of fire retardancy for both HIPS and ABS polymers, independently of the molecular structure of Component C. Alternatively, fire retarded compositions containing Component D in addition to Components B and C (Examples 53-64, Table 6) provide the required level of fire retardancy to the polymer material at a total fire retardant loading ranging from 12.5% (Example 55) to 20.8% (Example 63). For example, a total amount of fire retardant combination comprising Components B, C1 and D, demonstrated by Examples 53-55 and 57-59, may vary from 12.5% to 16.8%. It is significantly lower when compared with a conventionally used combination of Components C1 and D (a total amount of 21.4 wt %—Ref 9, 10). The examples indicate that very low loads of Component B (6-8 wt %), bromine of Component C (45 wt %) and component D (2-3 wt %) may be sufficient for providing a high level of fire retardancy of the styrene polymer composition. This is true for both HIPS and ABS, independently of the molecular structure of the fire retardant (Component C).

TABLE 6

| | | | | | | | | | | | | | | | |
|---|---|---|---|---|---|---|---|---|---|---|---|---|---|---|---|
| Example | | | | | | | | | | Total | LOI, | UL-94 | Burning | UL-94 | Burning |
| No. | A | Wt. % | B | Wt. % | C | Wt. % | Br % | D | Wt. % | FR % | % O₂ | 3.2 mm | time, sec | 1.6 mm | time, sec |

Example (metal oxide free compositions)

| | | | | | | | | | | | | | | | |
|---|---|---|---|---|---|---|---|---|---|---|---|---|---|---|---|
| 33 | A1 | 79.6 | B1 | 10 | C1 | 10.4 | 8.5 | — | 0 | 20.4 | 30.6 | V-0 | 1.1 | V-0 | 1.6 |
| 45 | A1 | 81.6 | B1 | 8 | C1 | 10.4 | 8.5 | — | 0 | 18.4 | | | | V-0 | 1.6 |
| 46 | A2 | 79.6 | B1 | 10 | C1 | 10.4 | 8.5 | — | 0 | 20.4 | | | | V-0 | 1.1 |
| 47 | A2 | 81.6 | B1 | 8 | C1 | 10.4 | 8.5 | — | 0 | 18.4 | | | | V-0 | 1.3 |
| 48 | A1 | 79.5 | B1 | 10 | C2 | 10.5 | 8.5 | — | 0 | 20.5 | | V-0 | 3.7 | V-0 | 4.2 |
| 18 | A1 | 78.2 | B1 | 10 | C3 | 11.8 | 8.5 | — | 0 | 21.8 | 30.7 | V-0 | 2.1 | V-0 | 1.3 |
| 49 | A2 | 73.3 | B1 | 10 | C6 | 16.3 | 8.5 | — | 0 | 26.7 | | | | V-0 | 1.0 |
| 50 | A2 | 75.5 | B1 | 10 | C5 | 14.5 | 8.5 | — | 0 | 24.5 | | | | V-0 | 1.0 |
| 51 | A2 | 77.5 | B1 | 8 | C5 | 14.5 | 8.5 | — | 0 | 22.5 | 34.8 | V-0 | 0.7 | V-0 | 0.5 |
| 52 | A2 | 77.2 | B1 | 10 | C5 | 12.8 | 7.5 | — | 0 | 22.8 | | | | V-0 | 1.1 |

Example (compositions containing reduced content both metal oxide and bromine)

| | | | | | | | | | | | | | | | |
|---|---|---|---|---|---|---|---|---|---|---|---|---|---|---|---|
| 53 | A1 | 83.6 | B1 | 8 | C1 | 6.1 | 5.0 | D1 | 2.0 | 16.1 | 30.1 | V-0 | 0.2 | V-0 | 0.6 |
| 54 | A1 | 85.9 | B1 | 6 | C1 | 6.1 | 5.0 | D1 | 2.0 | 14.1 | | | | V-0 | 0.3 |
| 55 | A1 | 87.5 | B1 | 6 | C1 | 4.9 | 4.0 | D1 | 1.6 | 12.5 | | | | V-0 | 0.3 |
| 56 | A1 | 83.8 | B1 | 8 | C2 | 6.2 | 5.0 | D1 | 2.0 | 16.2 | 31.7 | V-0 | 0.0 | V-0 | 0.8 |
| 26 | A1 | 83.1 | B1 | 8 | C3 | 6.9 | 5.0 | D1 | 2.0 | 16.9 | 30.0 | V-0 | 0.3 | V-0 | 1.3 |
| 57 | A2 | 83.2 | B1 | 8 | C1 | 6.1 | 5.0 | D1 | 2.7 | 16.8 | | | | V-0 | 1.5 |
| 58 | A2 | 85.2 | B1 | 6 | C1 | 6.1 | 5.0 | D1 | 2.7 | 14.8 | | | | V-0 | 2.5 |
| 59 | A2 | 84.9 | B1 | 6 | C1 | 4.9 | 4.0 | D1 | 2.2 | 13.1 | | | | V-0 | 1.6 |
| 60 | A2 | 80.8 | B1 | 8 | C5 | 8.5 | 5.0 | D1 | 2.7 | 19.2 | 32.8 | | 1.0 | V-0 | 0.5 |
| 61 | A2 | 83.3 | B1 | 6 | C5 | 8.5 | 5.0 | D1 | 2.2 | 16.7 | | | | V-0 | 0.7 |
| 62 | A1 | 82.5 | B1 | 8 | C8 | 7.5 | 5.0 | D1 | 2.0 | 17.5 | 28.7 | V-0 | 0.2 | V-0 | 0.8 |
| 63 | A2 | 79.2 | B1 | 8 | C6 | 9.6 | 5.0 | D1 | 2.7 | 20.8 | | | | V-0 | 0.5 |
| 64 | A2 | 82.3 | B1 | 6 | C6 | 9.6 | 5.0 | D1 | 2.2 | 17.7 | | | | V-0 | 0.7 |

Comparative example

| | | | | | | | | | | | | | | |
|---|---|---|---|---|---|---|---|---|---|---|---|---|---|---|
| Ref. 9 | A1 | 78.6 | — | 0 | C1 | 14.6 | 12 | D1 | 6.8 | 21.4 | V-0 | 0.1 | V-0 | 1.3 |
| Ref. 10 | A2 | 78.6 | — | 0 | C1 | 14.6 | 12 | D1 | 6.8 | 21.4 | V-0 | 0.2 | V-0 | 0.8 |

### EXAMPLES 65-98 AND COMPARATIVE EXAMPLES REF. 11-15

Either a low density polyethylene or a polypropylene homo- and co-polymer was used as Component A. Various amounts of Components B, C and D were admixed with the Component A in a granulated form (Tables 7-10). Regular amounts of antioxidants, lubricants and anti-dripping agent, when them were applied, were added to the mixture on the expense of the polymer, as far as wt % is concerned, in the composition. Mixing was done in a Brabender mixer of 55 cm⁵ volume capacity at 50 rotations per minute for a desired time and at a desired temperature, which are characteristic for each polymer under the corresponding series of experiments. Specimens of 3.2 mm or 1.6 mm thickness were prepared by compression molding in a hot press at 200° C., cooling to room temperature and cutting to standard test pieces.

The flammability was tested by the limiting oxygen index (hereinafter referred to as “LOI”) method, according to ASTM D-2863 and by UL-94 test (Underwriters Laboratories) with bottom ignition by a standard burner flame for two successive 10-second intervals. Five test-pieces of each composition were tested and the burning time, given in each example, are averages of all five tested pieces.

Comparative Examples, Ref. 11 and Ref. 12 (Table 7), demonstrate that 22% wt. of aromatic bromine of Component C and 11 wt % of Component D (a total amount of 37.5 wt % of a fire retardant combination) are usually required for providing a high level of fire retardancy in polyolefins (V-0 rating both in 3.2 mm thickness and in 1.6 mm thickness specimens). In the Comparative Example Ref 15 (Table 7), the use of Component B together with Component D, but without Component C, resulted in a lack of fire retardancy as was shown in the ULI-94 burning test.

Comparative Examples Ref. 13 and Ref. 14 Cable 7) show that a conventionally used halogen containing fire retardant, which contains aliphatic bromine in Component C, either alone (C4) or combined with aromatic bromine (C7), in combination with Component D provides V-O UL-94 rating for specimens with a thickness of 3.2 mmn at a lower total amount of fire retardant combination (23.8 and 31.8 wt %) and at lower content of Component C(C4 or C7)) and even Component D.

TABLE 7
Comparative Examples of polyolefins based fire retarded compositions

| Example | | | | | | | | | | | LOI, | UL-94 | UL-94 |
|---|---|---|---|---|---|---|---|---|---|---|---|---|---|
| No. | A | Wt. % | B | Wt. % | C | Wt. % | Br % | D | Wt. % | Total FR % | % O₂ | 3.2 mm | 1.6 mm |
| Ref. 11 | A3/A4 | 62.5 | — | 0 | C1/C2 | 26.5/26.8 | 22 | D1 | 11.0 | 37.5/37.8 | 28.4 | V-0 | V-0 |
| Ref. 12 | A5 | 62.5 | — | 0 | C1 | 26.5 | 22 | D1 | 11.0 | 37.5 | 28.6 | V-0 | V-0 |
| Ref. 13 | A3/A4 | 68.2 | — | 0 | C4 | 20.3 | 14 | D1 | 11.5 | 31.8 | 26.7 | V-0 | V-0/NR |
| Ref. 14 | A3/A4 | 76.2 | — | 0 | C7 | 17.8 | 12 | D1 | 6.0 | 23.8 | 32.1 | V-0 | V-2 |
| Ref. 15 | A3/A4 | 79.0 | B1 | 10 | — | 0 | 0 | D1 | 11.0 | 21.0 | | NR | NR |

However, a fire retardant combination containing the Component C4 provides UL-94 V-0 rating for specimens with a thickness of 1.6 mm in homo-polymer only, but not in co-polymer, while the fire retardant composition containing Component C7 was unable to provide UL-94 NI-0 (V-1) rating for specimens with thickness of 1.6 mm.

The use of Component B (heat expandable graphite) allows either to totally eliminate the Component D from the fire retardant composition (metal oxide-free composition), while preserving the content of halogen of Component C (Examples 65-67 in Table 8 and Examples 71-77 in Table 9), or reducing the amount of halogen of Component C to half and the amount of Component D to half and even lower (Examples 68-70 in Table 8 and Examples 78-84 in Table 9). All compositions provide V-0 or V-1 rating in the UL-94 burning test of specimens with a thickness of both 3.2 mm and 1.6 mm, and high values of LOI. This is true both for LDPE and PP, independently of the molecular structure of the fire retardant (Component C).

The amount of Components B, C and D may be further reduced (Examples 85-111 in Table 10).

A total load of fire retardant combination in a metal oxide-free polyolefin based composition ranges from 24.3% to 36.5%. Such composition is shown to impart high flame retardancy to polyolefins (Tables 8-10).

TABLE 8

| | | | | | | | | | | | | | |
|---|---|---|---|---|---|---|---|---|---|---|---|---|---|
| Example | | | | | | | | | | | LOI, | UL-94 | Burning |
| No. | A | Wt. % | B | Wt. % | C | Wt. % | Br % | D | Wt. % | Total FR | % O₂ | 3.2 mm | time, sec |

Example (metal oxide free compositions)

| | | | | | | | | | | | | | |
|---|---|---|---|---|---|---|---|---|---|---|---|---|---|
| 65 | A5 | 63.5 | B1 | 10 | C1 | 26.5 | 22 | — | 0 | 36.5 | 32.0 | V-0 | 1.3 |
| 66 | A5 | 69.7 | B1 | 10 | C4 | 20.3 | 14 | — | 0 | 30.3 | 30.5 | V-0 | 0.1 |
| 67 | A5 | 82.3 | B1 | 10 | C7 | 17.8 | 12 | — | 0 | 27.8 | 30.1 | V-0 | 3.1 |

Example (compositions containing reduced content both metal oxide and bromine)

| | | | | | | | | | | | | | |
|---|---|---|---|---|---|---|---|---|---|---|---|---|---|
| 68 | A5 | 71.2 | B1 | 10 | C1 | 13.3 | 11 | D1 | 5.5 | 28.8 | 34.6 | V-0 | 0.6 |
| 69 | A5 | 86.3 | B1 | 10 | C4 | 10.2 | 7 | D1 | 3.5 | 23.7 | 32.2 | V-0 | 0.7 |
| 70 | A5 | 88.5 | B1 | 10 | C7 | 9.0 | 6 | D1 | 2.5 | 21.5 | 32.2 | V-0 | 1.6 |

TABLE 9

| | | | | | | | | | | | | | | | |
|---|---|---|---|---|---|---|---|---|---|---|---|---|---|---|---|
| Example | | | | | | | | | | Total | LOI, | UL-94 | Burning | UL-94 | Burning |
| No. | A | Wt. % | B | Wt. % | C | Wt. % | Br % | D | Wt. % | FR % | % O₂ | 3.2 mm | time, sec | 1.6 mm | time, sec |

Example (metal oxide free compositions)

| | | | | | | | | | | | | | | | |
|---|---|---|---|---|---|---|---|---|---|---|---|---|---|---|---|
| 71 | A4 | 60.0 | B1 | 13.5 | C1 | 26.5 | 22 | — | 0 | 40.0 | 31.8 | V-0 | 0.4 | V-0 | 2.7 |
| 72 | A4 | 63.5 | B1 | 10 | C1 | 26.5 | 22 | — | 0 | 36.5 | 31.5 | V-0 | 0.6 | V-0 | 3.5 |
| 73 | A4 | 63.2 | B1 | 10 | C2 | 26.8 | 22 | — | 0 | 36.8 | 31.0 | V-0 | 1.1 | | |
| 74 | A4 | 69.7 | B1 | 10 | C4 | 20.3 | 14 | — | 0 | 30.3 | | V-0 | 1.2 | V-0 | 1.0 |
| 75 | A3 | 69.7 | B1 | 10 | C4 | 20.3 | 14 | — | 0 | 30.3 | 26.7 | V-0 | 0.7 | | |
| 76 | A4 | 72.2 | B1 | 10 | C7 | 17.8 | 12 | — | 0 | 27.8 | 31.0 | V-0 | 1.9 | V-1 | 6.2 |
| 77 | A3 | 72.2 | B1 | 10 | C7 | 17.8 | 12 | — | 0 | 27.8 | 29.3 | V-0 | 2.0 | | |

Example (compositions containing reduced content both metal oxide and bromine)

| | | | | | | | | | | | | | | | |
|---|---|---|---|---|---|---|---|---|---|---|---|---|---|---|---|
| 78 | A4 | 71.2 | B1 | 10 | C1 | 13.3 | 11 | D1 | 5.5 | 28.8 | 32.0 | V-0 | 0.5 | V-0 | 0.0 |
| 79 | A3 | 71.2 | B1 | 10 | C1 | 13.3 | 11 | D1 | 5.5 | 28.8 | 31.8 | V-0 | 1.0 | | |
| 80 | A4 | 71.1 | B1 | 10 | C2 | 13.4 | 11 | D1 | 5.5 | 28.9 | 32.0 | V-0 | 0.2 | | |
| 81 | A3 | 76.3 | B1 | 10 | C4 | 10.2 | 7 | D1 | 3.5 | 23.7 | 30.7 | V-0 | 1.5 | | |
| 82 | A4 | 74.3 | B1 | 10 | C4 | 10.2 | 7 | D1 | 5.5 | 25.7 | | V-0 | 0.0 | V-0 | 0.0 |
| 83 | A4 | 78.5 | B1 | 10 | C7 | 9.0 | 6 | D1 | 2.5 | 21.5 | 31.3 | V-0 | 0.4 | V-0 | 1.0 |
| 84 | A3 | 78.5 | B1 | 10 | C7 | 9.0 | 6 | D1 | 2.5 | 21.5 | 30.2 | V-0 | 0.8 | | |

TABLE 10

| | | | | | | | | | | | | | | |
|---|---|---|---|---|---|---|---|---|---|---|---|---|---|---|
| Example | | | | | | | | | | | UL-94 | Burning | UL-94 | Burning |
| No. | A | Wt. % | B | Wt. % | C | Wt. % | Br % | D | Wt. % | Total FR % | 3.2 mm | time, sec | 1.6 mm | time, sec |

Example (metal oxide free compositions)

| | | | | | | | | | | | | | | |
|---|---|---|---|---|---|---|---|---|---|---|---|---|---|---|
| 72 | A4 | 63.5 | B1 | 10 | C1 | 26.5 | 22 | — | 0 | 36.5 | V-0 | 0.6 | V-0 | 3.5 |
| 85 | A4 | 69.3 | B1 | 10 | C1 | 20.7 | 17 | — | 0 | 30.7 | | | V-0 | 2.7 |
| 86 | A4 | 71.3 | B1 | 8 | C1 | 20.7 | 17 | — | 0 | 28.7 | | | V-0 | 3.5 |
| 87 | A4 | 73.7 | B1 | 8 | C1 | 18.3 | 15 | — | 0 | 26.3 | | | V-0 | 3.0 |
| 88 | A4 | 75.7 | B1 | 6 | C1 | 18.3 | 15 | — | 0 | 24.3 | | | V-1 | 5.5 |
| 89 | A4 | 77.9 | B1 | 5 | C1 | 17.1 | 14 | — | 0 | 22.1 | | | NR | 25.4 |
| 74 | A4 | 69.7 | B1 | 10 | C4 | 20.3 | 14 | — | 0 | 30.3 | V-0 | 1.2 | V-0 | 1.0 |
| 90 | A4 | 73.7 | B1 | 6 | C4 | 20.3 | 14 | — | 0 | 26.3 | V-0/V-1 | 4.4 | | |
| 91 | A4 | 74.6 | B1 | 8 | C4 | 17.4 | 12 | — | 0 | 25.4 | | | V-0 | 1.3 |
| 92 | A4 | 76.6 | B1 | 6 | C4 | 17.4 | 12 | — | 0 | 23.4 | | | NR | 20.7 |
| 93 | A4 | 75.6 | B1 | 10 | C4 | 14.4 | 10 | — | 0 | 24.4 | V-0 | 2.0 | V-0/NR | 6.9 |
| 76 | A4 | 72.2 | B1 | 10 | C7 | 17.8 | 12 | — | 0 | 27.8 | V-0 | 1.9 | V-1 | 6.2 |
| 94 | A4 | 74.2 | B1 | 8 | C7 | 17.8 | 12 | — | 0 | 25.8 | V-0/V-1 | 4.2 | NR | 27.4 |
| 95 | A4 | 75.2 | B1 | 10 | C7 | 14.8 | 10 | — | 0 | 24.8 | V-0 | 3.2 | | |

Example (compositions containing reduced content both metal oxide and bromine)

| | | | | | | | | | | | | | | |
|---|---|---|---|---|---|---|---|---|---|---|---|---|---|---|
| 78 | A4 | 71.2 | B1 | 10 | C1 | 13.3 | 11 | D1 | 5.5 | 28.8 | V-0 | 0.5 | V-0 | 0.0 |
| 96 | A4 | 75.2 | B1 | 6 | C1 | 13.3 | 11 | D1 | 5.5 | 24.8 | | | V-0 | 0.6 |
| 97 | A4 | 75.6 | B1 | 8 | C1 | 11.6 | 9.5 | D1 | 4.8 | 24.4 | | | V-0 | 0.8 |
| 98 | A4 | 77.6 | B1 | 6 | C1 | 11.6 | 9.5 | D1 | 4.8 | 22.4 | | | V-0 | 1.1 |
| 99 | A4 | 80.0 | B1 | 6 | C1 | 10.0 | 8 | D1 | 4.0 | 20.0 | | | V-0 | 2.7 |
| 100 | A4 | 82.0 | B1 | 6 | C1 | 8.5 | 7 | D1 | 3.5 | 18.0 | | | V-1 | 6.7 |
| 101 | A4 | 84.7 | B1 | 5 | C1 | 7.3 | 6 | D1 | 3.0 | 15.3 | | | NR | 48.6 |
| 82 | A4 | 74.3 | B1 | 10 | C4 | 10.2 | 7 | D1 | 5.5 | 25.7 | V-0 | 0.0 | V-0 | 0.0 |
| 102 | A4 | 78.3 | B1 | 8 | C4 | 10.2 | 7 | D1 | 3.5 | 21.7 | V-0 | 1.4 | V-0 | 1.4 |
| 103 | A4 | 78.6 | B1 | 8 | C4 | 9.0 | 6 | D1 | 4.4 | 21.4 | | | V-0 | 1.3 |
| 104 | A4 | 80.6 | B1 | 6 | C4 | 9.0 | 6 | D1 | 4.4 | 19.4 | | | V-0 | 2.2 |
| 105 | A4 | 81.5 | B1 | 6 | C4 | 9.0 | 6 | D1 | 3.5 | 18.5 | | | V-0 | 1.9 |
| 106 | A4 | 83.1 | B1 | 6 | C4 | 7.4 | 5 | D1 | 3.5 | 16.9 | | | NR | 18.1 |
| 83 | A4 | 78.5 | B1 | 10 | C7 | 9.0 | 6 | D1 | 2.5 | 21.5 | V-0 | 0.4 | V-0 | 1.0 |
| 107 | A4 | 80.5 | B1 | 8 | C7 | 9.0 | 6 | D1 | 2.5 | 19.5 | V-0 | 2.8 | | |
| 108 | A4 | 80.0 | B1 | 8 | C7 | 9.0 | 6 | D1 | 3.0 | 20.0 | | | V-0 | 0.4 |
| 109 | A4 | 82.4 | B1 | 6 | C7 | 9.0 | 6 | D1 | 2.6 | 17.6 | | | V-0 | 1.8 |
| 110 | A4 | 84.0 | B1 | 6 | C7 | 7.4 | 5 | D1 | 2.6 | 16.0 | | | V-0 | 3.6 |
| 111 | A4 | 86.1 | B1 | 5 | C7 | 6.6 | 4.5 | D1 | 2.3 | 13.9 | | | V-1 | 6.8 |
| 112 | A4 | 87.1 | B1 | 5 | C7 | 5.9 | 4.0 | D1 | 2.0 | 12.9 | | | NR | 39.8 |

TABLE 11

| | | | | | | | | | | | | | | | | |
|---|---|---|---|---|---|---|---|---|---|---|---|---|---|---|---|---|
| Ex- | | | | | | | | | | | | | | Burning | | Burning |
| ample | | Wt. | | | | | | | | Total | | | UL-94 | time, | UL-94 | time, |
| No. | A | % | B | Wt. % | C | Wt. % | Br % | D | Wt. % | FR % | Additive | Wt. % | 1.6 mm | sec | 0.8 mm | sec |

Example (compositions containing reduced content both metal oxide and bromine)

| | | | | | | | | | | | | | | | | |
|---|---|---|---|---|---|---|---|---|---|---|---|---|---|---|---|---|
| 78 | A4 | 71.2 | B1 | 10 | C1 | 13.3 | 11 | D1 | 5.5 | 28.8 | | | V-0 | 0.0 | V-2 | 2.0 |
| 113 | A4 | 66.0 | B1 | 10 | C1 | 17.0 | 14 | D1 | 7.0 | 34.0 | | | V-0 | 0.5 | V-0 | 1.1 |
| 114 | A4 | 70.7 | B1 | 10 | C1 | 13.3 | 11 | D1 | 5.5 | 28.8 | teflon | 0.5 | V-0 | 1.0 | V-0 | 2.2 |
| 115 | A4 | 61.2 | B1 | 10 | C1 | 13.3 | 11 | D1 | 5.5 | 28.8 | Talc, | 10.0, | V-0 | 0.5 | V-0 | 0.6 |
| | | | | | | | | | | | teflon | 0.5 | | | | |

Comparative example

| | | | | | | | | | | | | | | |
|---|---|---|---|---|---|---|---|---|---|---|---|---|---|---|
| Ref. 11 | A4 | 62.5 | — | 0 | C1 | 26.5 | 22 | D1 | 11 | 37.5 | V-0 | 0.2 | V-0 | 1.0 |

Increasing the total amount of fire retardant components to 40% (above 36.5%) by weight, practically does not further increase the fire retardancy (Examples 71 and 72, Table 9) but deteriorates slightly the mechanical properties of the polymer composition. A further decreasing the total amount of fire retardant components results in a lack of fire retardancy in the UL-94 burning test (Examples 89, 92, Table 10). Examples 71, 72 (Table 9) demonstrate that increasing the amount of Component B to 13.5 wt % does practically not improve fire retardancy, while decreasing the amount of Component B to 6-8 wt % still provides VD/V-1 rating (Examples 72, and 85-88, 74 and 90-91, Table 10).

A total load of a fire retardant combination containing all three components in a fire retarded polyolefin composition ranging from 13.9% to 28.9% by weight. A further decreasing the total amount of fire retardant components results in a lack of fire retardancy in the UL-94 burning test (Examples 101, 112, Table 10). Such composition containing reduced amounts of both Component D (to 2.3%) and bromine of Component C (to 4.5%) providing a high level of flame retardancy in polyolefins (Tables 8, 9 and 10>. The content of Component B may be reduced to 5-8 wt % while preserving the flame retardancy efficiency of the composition.

A comparison between the fire retardant combination of the present invention and the conventionally used fire retarded combination, e.g. based on Cl, shows that the use of Component B (heat expandable graphite) allows reducing the total amount of the fire retardant components in a polyolefin fire retardant composition to 20 wt % (Example 99) from 37.5 wt % (Ref 11), while still providing a high level of fire retardancy (V-0 at 1.6 mm). This was achieved at very low amounts of Component B (6% wt %), bromine of Component Cl (8 wt %) and Component D (4 wt %).

### EXAMPLES 72, 74, 76, 78, 82, 83, 113-115 AND COMPARATIVE EXAMPLES REF. 11

Polypropylene co-polymer was used as Component A. The starting materials (Components A, B, C and D) were blended in a co-rotating twin-screw compounding machine using formulation ratios as shown in Tables 9 to 11. Regular amounts of antioxidants, lubricants and anti-dripping agent, when were applied, were added to the mixture on the expense of the polymer, as far as wt % is concerned, in the composition. The test-specimens were prepared by injection molding. Fire retardancy was evaluated by vertical flame test according to UL-94 as described above.

The toughness of specimens was measured as Izod notched impact strength according to ASTM D 256. The UV stability was assessed by measuring the toughness decrease after specimen's exposure to the Xenon arc according to ASTM-4459/99 (300 W/m², 290-850 nm, 300 hours). The tensile properties were measured according to ASTM D 638-95. The flow ability was measured as melt flow index IFl) according to ASTM D 1238-82 or as melt viscosity by capillary rheometry. The thermo-mechanical properties were measured as heat distortion test (HDI) according to ASTM D 648-72.

The Blooming Test was Conducted as Follows:

Following a visual inspection of the specimen, clean places without any visual defects were chosen and square samples having a side of about 1 cm were cut, coated with gold and investigated in SEM as zero time specimens. Similar samples were introduced in an oven at 65° C. for two weeks. When taken out of the oven, the specimens were gold plated and investigated in the SEM.

The fire retardant combination of the invention provides a high level of fire retardancy (V-0 or V-1 rating for specimens with a thickness of 1.6 mm) of fire retarded polypropylene compositions prepared via compounding and injection molding in accordance with Examples 72, 74, 76, 78, 82, 83.

The UL-94 V-0 rating of specimens with a thickness of 0.8 mm represents an extremely high level of fire retardancy for polyolefins. Using a conventional fire retardant composition containing 22 wt % halogen of Component C1 and 11 wt % Component D (Comparative Example Ref. 11 in Table 11) at a total fire retardant amount of 37.5% allows to achieve this rating. The Example 113 (Table 11) shows that the use of a fire retardant combination, containing Component B together with reduced amounts of both the bromine (14%) and antimony oxide (7%) at a total fire retardant loading in polymer composition of 34% provides also UL-94 V-0 rating for specimens with a thickness of 0.8 mm.

In addition, the polymer material may contain other kinds of additives such as a filler or an anti-dripping agent or others. The addition of teflon or teflon with talc allows to increase the fire retardancy level as shown in Examples 114 and 115, compared to Example 78 Cable 11).

The high level of fire retardancy of fire retarded polymer composition, such as polystyrenes, polyolefins and polyesters containing the fire retardant combination of the present invention, is accompanied by advantages with respect to other properties when compared to the state-of-the-art halogen-containing fire retardant compositions. As compared to the conventional used fire retardant polymer compositions, the fire retardant polymer compositions of the present invention, which contain heat expandable graphite, a reduced halogen content and a zero to low content of antimony oxide, exhibit reduced smoke emission, higher toughness, higher UV stability, higher HDT, and lower blooming of halogen-containing fire retardant. The addition of the Component B (heat expandable graphite) to the fire retardant composition has practically no effect on such properties of polymer materials as electrical insulating properties, tensile modulus, strength, and melt viscosity.

1. A fire retardant polymer composition comprising heat expandable graphite (HEG) and at least one halogen-containing fire retardant, wherein the polymer component of said composition is selected from the group consisting of polystyrenes, polyesters, polyethylene, polypropylene and copolymers of propylene with ethylene.

2. A fire retardant composition according to claim 1, wherein the halogen-containing fire retardant is a bromine fire-retardant.

3. A fire retardant compositions according to claim 1, wherein the halogen containing fire retardant is a chlorine-fire retardant.

4. A fire retardant composition according to any one of claims 1 to 3, wherein the heat expandable graphite (HEG) and the halogen-containing fire-retardant are contained in the polymer composition in a total amount ranging from about 6.5 to about 40% by weight.

5. A fire retardant composition according to claim 4, wherein the polymer is selected from the group consisting of polystyrens and polyesters and the heat expandable graphite (HEG) and the halogen-containing fire-retardant are contained in the polymer composition in a total amount ranging from about 6.5 to about 30% by weight.

6. A fire retardant composition according to claim 4, wherein the polymer is a polyolefin and the heat expandable graphite (HEG) and the halogen-containing fire-retardant are contained in the polymer composition in a total amount ranging from about 24.3 to about 40% by weight.

7. A fire retardant composition according to any one of claims 1 to 6, further comprising a metal oxide fire retardant.

8. Fire retardant composition according to claim 7, wherein the metal oxide fire retardant is selected from the group consisting of antimony oxide, zinc oxide, zinc borate, and ferric oxide.

9. Fire retardant composition according to claim 8, wherein the antimony oxide fire retardant is antimony trioxide or antimony pentaoxide.

10. A fire retardant composition according to any one of claims 7 to 9, wherein the heat expandable graphite (HEG), the halogen-containing fire-retardant and the metal oxide are contained in the polymer composition in a total amount ranging from about 7.2 to about 34% by weight.

11. A fire retardant composition according to claim 10, wherein the polymer is selected from the group consisting of polystyrens and polyesters and the heat expandable graphite (HEG), the halogen-containing fire-retardant and the metal oxide are contained in the polymer composition in a total amount ranging from about 7.2 to about 21.5% by weight.

12. A fire retardant composition according to claim 11, wherein the polymer is selected from the group consisting of polystyrens and polyesters and the heat expandable graphite (HEG), the halogen-containing fire-retardant and the metal oxide are contained in the polymer composition in a total amount ranging from about 7.2 to about 16.7% by weight.

13. A fire retardant composition according to claim 10, wherein the polymer is polyolefin and the heat expandable graphite (HEG), the halogen-containing fire-retardant and the metal oxide are contained in the polymer composition in a total amount ranging from about 13.9 to about 34% by weight.

14. A fire retardant composition according to claim 13, wherein the polymer is polyolefin and the heat expandable graphite (HEG), the halogen-containing fire-retardant and the metal oxide are contained in the polymer composition in a total amount ranging from about 16 to about 20% by weight.

15. A fire retarded polymer composition according to any one of claims 1 to 5 and 7 to 12 comprising:
(a) a polymer selected from the group consisting of polystyrenes or polyesters at a percent weight which totals to 100% by weight the composition;
(b) from about 2 to about 15 percent by weight of heat expandable graphite,
(c) a halogen-containing fire retardant in an amount corresponding to from about 2 to about 11% by weight of halogen; and, optionally,
(d) 0 to about 3.4 percent by weight of a metal oxide.

16. A fire retarded polymer composition according to claim 15 comprising:
(a) a polymer selected from the group consisting of polystyrenes or polyesters at a percent weight which totals to 100% by weight the composition;
(b) from about 2 to about 6 percent by weight of heat expandable graphite,
(c) a halogen-containing fire retardant in an amount corresponding to from about 2 to about 8.5% by weight of halogen; and, optionally,
(d) 0 to about 2.2 percent by weight of a metal oxide.

17. A fire retarded polymer composition according to any one of claims 1 to 4, 6 to 10 and 13 to 14 comprising:
(a) a polyolefin polymer at a percent weight which totals to 100% by weight the composition;
(b) from about 5 to about 13.5 percent by weight of heat expandable graphite,
(c) a halogen-containing fire retardant in an amount corresponding to from about 4 to about 22% by weight of halogen; and optionally,
(d) 0 to about 7 percent by weight of a metal oxide.

18. A fire retarded polymer composition according to claim 17 comprising
(a) a polyolefin polymer at a percent weight which totals to 100% by weight the composition;
(b) from about 6 to about 8 percent by weight of heat expandable graphite,
(c) a halogen-containing fire retardant in an amount corresponding to from about 5 to about 15% by weight of halogen; and optionally,
(d) 0 to about 4 percent by weight of a metal oxide.

19. A fire retardant composition according to any one of claims 1 to 18, wherein the heat expandable graphite is obtained by any conventional route from a natural graphite or artificial graphite.

20. A fire retardant composition according to claim 19, wherein the heat expandable graphite, produced by oxidation of a natural graphite or artificial graphite in sulfuric acid or in nitric acid, can be additionally allowed to neutralize with a basic material.

21. A fire retardant composition according to any one of claims 19 and 20, wherein the heat expandable graphite is obtained by any conventional route from a natural graphite or artificial graphite, and which upon rapid heating from room temperature to 900° C. has a weight loss of 10-40%.

22. A fire retardant composition according to any one of claims 19 to 21, wherein the heat expandable graphite is obtained by any conventional route from a natural graphite or artificial graphite, and which upon rapid heating from room temperature to 900° C. has a specific volume expansion of not less than 50 times.

23. A fire retardant composition according to any one of claims 19 to 22, wherein the heat expandable graphite has such a particle size distribution that not more than 25% by weight of graphite particles pass through a 75 mesh sieve.

24. A fire retardant composition according to any one of claims 1 to 23, wherein the heat expandable graphite particles is surface treated with a coupling agent.

25. A fire retardant composition according to any one of claims 1 to 24, wherein the halogen-containing fire retardant is selected from the group consisting of decabromodiphenyl oxide, decabromodiphenyl ethane, brominated trimethylphenyl indane, chlorine- or bromine containing cycloaliphatic compounds, tetrabromobisphenol A or tetrabromobisphenol A bis(2,3 dibromopropyl ether) or tetrabromobisphenol A based epoxy, chlorinated paraffin, chlorinated polethylene, pentabromobenzyl acrylate or poly(pentabromobenzyl acrylate), and compounds containing phosphorus, nitrogen or sulfur heteroatoms in the molecule

26. A fire retardant composition according to claim 25, wherein the halogen-containing fire retardant which contains phosphorus, nitrogen or sulfur heteroatoms in the molecule is tris(tribromoneopentyl) phosphate, tris(tribromophenyl)triazine or tetrabromobisphenol-S-bis(2,3dibromopropyl ether).

27. A fire retarded polymer composition according to any one of claims 1 to 26, wherein the polymer, the halogen-containing fire retardant and optionally, the metal oxide, each consists of either a single component or a mixture of components of the same category.

28. A fire retarded polymer composition according to any one of claims 1 to 27, wherein the polymer is a polymer or mixture of polymers characterized in neither autonomously forming char, nor cross-linking themselves under flame.

29. A fire retarded polymer composition according to any one of claims 1 to 5, 7 to 12, 15, 16 and 19 to 28, wherein the polymer is selected from the group consisting of homopolymers of styrene, rubber modified high-impact polystyrenes (HIPS), and acrylonitrile-butadiene-styrene copolymers (ABS).

30. A fire retarded polymer composition to any one of claims 1 to 5, 7 to 12, 15, 16 and 19 to 28, wherein the polymer is selected from the group consisting of polybutylene terphthalate and polyethylene terphthalate.

31. A fire retarded polymer composition according to any one of claims 1 to 4, 6 to 10, 13, 14, 17, 18 and 19 to 28, wherein the polyolefin polymer is selected from the group consisting of homopolymers of ethylene comprising high density polyethylene (HDPE), low density polyethylene (LDPE), linear low density polyethylene (LLDPE), homopolymers of polypropylene (PP homo-polymers), and block or random copolymers of propylene with ethylene (UP co-polymers).

32. A fire retarded polymer composition according to any one of claims 1 to 5, 7 to 12, 15, 16 and 19 to 30, wherein the polymer is selected from the group consisting of mixtures of two or more of polystyrenes and/or polyesters with one another or with polymer or polymers of different types.

33. A fire retarded polymer composition according to any one of claims 1 to 4, 6 to 10, 13, 14, 17, 18 and 19 to 28, 31 and 32, wherein the polymer is selected from the group consisting of mixtures of two or more of polyolefines with one another or with polymer or polymers of different types.

34. A fire retarded polymer composition according to any one of claims 1 to 33, further comprising additives chosen from the group consisting of metal hydroxides, colorants, antioxidants, light stabilizers, light absorbing agents, process oils, coupling agents, lubricants, blowing agents and fillers, anti-dripping agents and cross-linking agents.

35. A Fire retarded polymer composition according to any one of claims 1 to 34, further comprising at least one coupling agent.

36. A fire retardant composition, substantially as described.
